(19) United States
(12) Patent Application Publication
(10) Pub. No.: US 2005/0175786 A1
(43) Pub. Date: Aug. 11, 2005

(54) Surface treatment applicator/dispenser

(76) Inventors: Brij P. Singh, North Royalton, OH (US); John J. Dietrich, Broadview Heights, OH (US)

Correspondence Address: H. Duane Switzer, Jones Day;North Point, 901 Lakeside Avenue, Cleveland, OH, 44114-1190, US

(21) Appl. No.: 11/039,988

(22) Filed: Jan. 21, 2005

Related U.S. Application Data
(60) Provisional application No. 60/538,774, filed on Jan. 23, 2004.

(51) Int. Cl. B05C 1/00; B05D 1/36

(52) U.S. Cl. 427/407.1; 118/200

(57) ABSTRACT

An applicator/dispenser having a tubular body with a solution chamber and an applicator pad. A solution within the solution chamber is separated from the applicator pad by a rupturable barrier that is selectively ruptured for wetting the pad with the solution which then is applied to a surface by wiping the pad across the surface.

### CROSS-REFERENCE TO RELATED APPLICATIONS

This application claims the benefit of the filing date of U.S. Provisional Application Ser. No. 60/538,774, filed Jan. 23, 2004, the entire disclosure of which is hereby incorporated herein by reference.

### BACKGROUND

This application relates to the art of hand-held applicator/dispensers that are used for applying solutions or coatings to surfaces.

### SUMMARY

A surface treatment applicator/dispenser has a solution chamber, an applicator pad and a passageway communicating between the chamber and pad. The passageway includes at least two spaced-apart independent passages so that air can flow in through one passage while solution flows out through another passage. A surface treatment solution in the chamber is separated from the passageway by a rupturable barrier. Rupturing the barrier releases the solution to flow through the passageway to the applicator pad.

The solution may be a cleaning solution, a treatment solution or a film forming solution. In the case of a film forming solution, the solution includes a hydrocarbon solvent, a film forming material of amphiphilic molecules and a drying agent. The drying agent may be, by way of example, tetrachlorosilane, methyltrichlorosilane or ethyltrichlorosilane, or other materials that keep any water that may be present in the solvent or in the solution chamber from reacting with the film forming material of amhiphilic molecules. The drying agent also may act as a catalyst to help polymerize the amphiphilic molecules into a thin film on a substrate surface when the solution is spread on a surface to which the amphiphilic molecules are chemically bondable.

For a solution of a hydrocarbon solvent, a film forming material of amphiphilic molecules and a drying agent, the film forming material of amphiphilic molecules is present in an amount that is 0.1 to 10.0% by volume of the total solution, and more preferably 0.5 to 2.0%. The drying agent or drying agent/catalyst is present in an effective amount that keeps any moisture from reacting with the film forming material before the solution is released from the solution chamber and spread on a surface.

When the film forming solution is applied to a substrate surface, the amphiphilic molecules self-assemble and bond to the surface in a continuous thin film after around one minute. The excess solution then is wiped off using a soft cloth or paper that will not scratch the surface.

### BRIEF DESCRIPTION OF THE DRAWING

FIG. 1 is a side elevational view of an applicator/dispenser in accordance with the present application;

FIG. 2 is a side elevational cross-sectional view thereof;

FIG. 3 is a side elevational cross-sectional view thereof without a tip member and a solution receptacle;

FIG. 4 is a side elevational cross-sectional view of a tip member used with the application/dispenser of FIGS. 1-3;

FIG. 5 is a cross-sectional elevational view taken generally on line 5-5 of FIG. 4;

FIG. 6 is a cross-sectional elevational view showing an alternative arrangement for attaching the tip member to the applicator/dispenser;

FIG. 7 is a partial cross-sectional elevational view of the applicator/dispenser of FIG. 6;

FIG. 8 is a side elevational view of another applicator/dispenser;

FIG. 9 is a side cross-sectional elevational view thereof;

FIG. 10 is an end elevational view taken generally on line 10-10 of FIG. 9;

FIG. 11 is an elevational view taken generally on line 11-11 of FIG. 8;

FIG. 12 is a cross-sectional elevational view taken generally on line 12-12 of FIG. 9;

FIG. 13 is a cross-sectional elevational view taken generally on line 13-13 of FIG. 8; and

FIG. 14 is a view similar to FIG. 2, but showing the applicator/dispenser bent to rupture an internal solution receptacle.

### DESCRIPTION

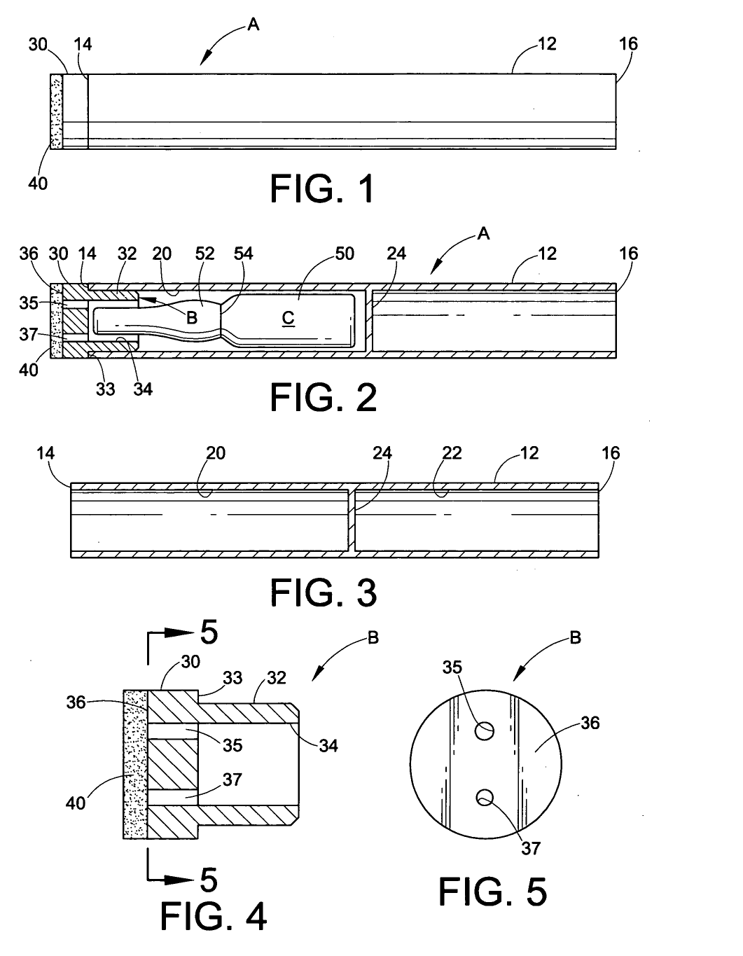

Referring now to the drawing, wherein the showings are for purposes of illustrating representative examples of an applicator/dispenser only and not for purposes of limiting same, FIGS. 1 and 2 show an applicator/dispenser A that includes an elongated generally cylindrical body 12 that is molded in one-piece of a suitable plastic material such as, but not necessarily limited to, polypropylene or polyethylene.

In the arrangement shown, elongated body 12 is generally tubular along its entire length between opposite front and rear ends 14 and 16. Front end 14 of elongated body 12 is open to a cylindrical solution chamber 20, while opposite rear end 16 is open to a cylindrical rear cavity 22.

Cylindrical solution chamber 20 and cylindrical rear cavity 22 have generally the same diameter, and the wall thickness of elongated body 12 is generally the same along the full length of the tubular body between its opposite ends 14, 16. However, it will be recognized that other arrangements are possible.

A solid partition wall 24 that extends generally perpendicular to the longitudinal axis of tubular body 12 separates solution chamber 20 and rear cavity 22 from one another. The location of partition wall 24 between opposite ends 14, 16 depends upon the desired size of solution chamber 20. However, in one arrangement that will be shown and described, it has been found advantageous to locate partition wall 24 closer to rear end 16 than to front end 14 to facilitate rupturing of a solution receptacle when elongated body 12 is bent to a curved shape along its length.

In the arrangement shown, the length of solution chamber 20 from front end 14 to partition wall 24 is around 55 percent of the total length of elongated body 12 between its opposite ends 14, 16. In general, the distance from front end 14 to partition wall 24 is not greater than around 75 percent of the total length of elongated body between its opposite ends 14, 16. The thickness of partition wall 24 in a direction axially of body 12 is around the same as the radial thickness of the peripheral wall of body 12. However, it will be recognized that other arrangements are possible.

FIGS. 4 and 5 show a tip member B having a generally cylindrical head portion 30 and a generally cylindrical tail portion 32. Head portion 30 has a larger diameter than tail portion 32 so that the two intersect at a circumferential radial shoulder 33. Tail portion 32 and the opening in front end 14 of body 12 are configured for close reception of tail portion 32 in the open end as shown in FIG. 2. Shoulder 33 abuts end 14, and the diameters of head portion 30 and the external surface of tubular body 12 are approximately the same. Tail portion 32 may be secured within the open front end 14 in any suitable manner such as by the use of adhesive, ultrasonic welding or a shrink sleeve. If a removable tip member is desired, it can be attached by way of a twist on/off connection or a snap connection.

Tail portion 32 of tip member B has a generally cylindrical longitudinal bore or cavity 34 therein that intersects head portion 30, and a pair of spaced-apart longitudinal passages 35, 37 extend between cavity 34 and the front face 36 of head portion 30.

A solution applying pad 40 is attached to front face 36 of tip member B in any suitable manner such as by way of adhesive, ultrasonic welding or a shrink sleeve. Pad 40 may take many forms depending on the solution to be applied to a surface and the nature of the surface. Pad 40 may be bonded to front face 36 only at the outer peripheral portion of the pad so as to not interfere with flow of treatment solution into the pad from passages 35, 37 and for distribution of the solution throughout the pad.

The applicator pad 40 can be of any suitable material that will not leave a residue on the substrate surface, will not dissolve in solvent, will not scratch the substrate surface and will not swell when wetted with the film forming solution. All of these properties are not required for all purposes, such as the use of a surface treatment/cleaning solution that does not contain solvent. The pad also may be slightly abrasive when used with a cleaning solution.

Substrate surfaces may be cleaned prior to application of the film forming solution thereto. An advantageous suitable material for the applicator pad is a polyurethane foam when the applicator/dispenser is used with a solution containing a film forming material of amphiphilic molecules. Other pad materials, including cloth and other plastic foams, may be used with film forming solutions and with other surface cleaning/treatment solutions. The applicator pad may be of varying thicknesses, but advantageously is around 1-5 millimeters thick, and more preferably 2-3 millimeters thick for applying film forming solution to substrate surfaces. The applicator pad may be flat or curved depending on the surfaces to be treated. An example of foam material that is suitable is available from Foamex International, Inc. An open cell polyurethane foam material that has been used is SIF FELT (a trademark of Foamex International, Inc.) grade 900Z with a firmness of 4.5 and a thickness of 0.125 inch.

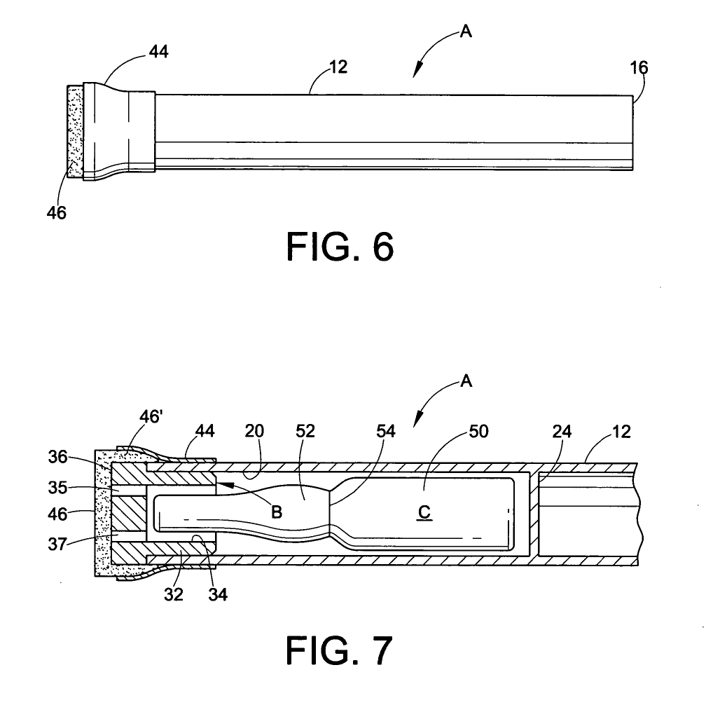

FIGS. 6 and 7 show an arrangement wherein the tip member is attached to the tubular body by a shrink sleeve 44. The foam pad 46 is large enough to include a peripheral pad portion 46′ that wraps over the outer periphery of head portion 30 on tip member B and extends along the outer periphery of tubular body 12. Obviously, pad 46 also may be generally cup-like in configuration. Heat is applied to shrink sleeve 44 to shrink it to the general configuration shown in FIG. 7 to both hold pad 46 on tip member B and hold tip member B to tubular body 12.

In FIG. 7, instead of a one-piece cup-like foam pad 46, 46′, a two-piece arrangement can be provided by using a flat disc portion 46 bonded to the front face of the tip member and a separate generally cylindrical sleeve portion 46′.

A sealed rupturable ampoule C that contains surface treatment solution is positioned within front chamber 20 prior to attachment of tip member B to tubular body 12. Ampoule C includes a main container body 50 having an elongated neck 52 extending therefrom that is received in cavity 34 of tail portion 32 in tip member B. The juncture between neck 52 and body 50 is scored as generally indicated at 54 so that it can be broken to release the contents of the ampoule. The ampoule may be of glass or another frangible or rupturable material.

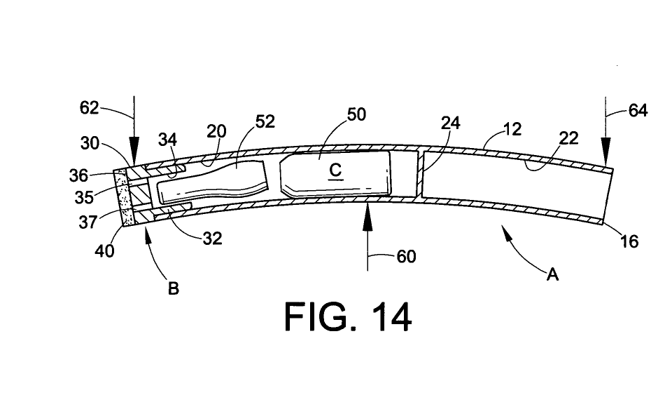

By way of example, with reference to FIG. 14, applicator/dispenser A may be gripped in a person's hands with the thumbs applying force in the general location of arrow 60 intermediate the ends of tubular body 12 or generally aligned with score line 54 on ampoule C while the fingers apply force in the opposite direction toward the ends of tubular body 12 as indicated by arrows 62, 64. This bends tubular body 12 as generally indicated in FIG. 14 so that neck 52 breaks off from ampoule body 50 to release the contents thereof. The bending force is then released and the tubular body returns to the shape of FIG. 2 except that the neck 52 is broken off from the ampoule C.

Solution then flows from the ampoule through cavity 34 and passages 35, 37 to pad 40 which is moved across a surface to apply the solution thereto. Obviously, tubular body 12 can be bent in other ways to rupture the solution chamber. For example, the tubular body can be held in one hand near one end while the other end is placed against a surface and bending force is applied to the tubular body. The tubular body also may be swung against an object to strike a blow that will rupture the solution receptacle.

The neck 52 is a loose fit within cavity 34 so that the neck will not block flow of solution through cavity 34 to passages 35, 37. The entire applicator/dispenser A may be shaken so that the solution flows through one or both of passages 35, 37 and wets applicator pad 40. The pad then is rubbed over a surface to be treated to apply the solution thereto. The applicator/dispenser may be shaken at intervals to facilitate flow of more solution to the applicator pad.

The applicator/dispenser of FIGS. 1-7 and 14 may be used for applying solutions to optical lenses, as well as for applying treatment solutions to other surfaces.

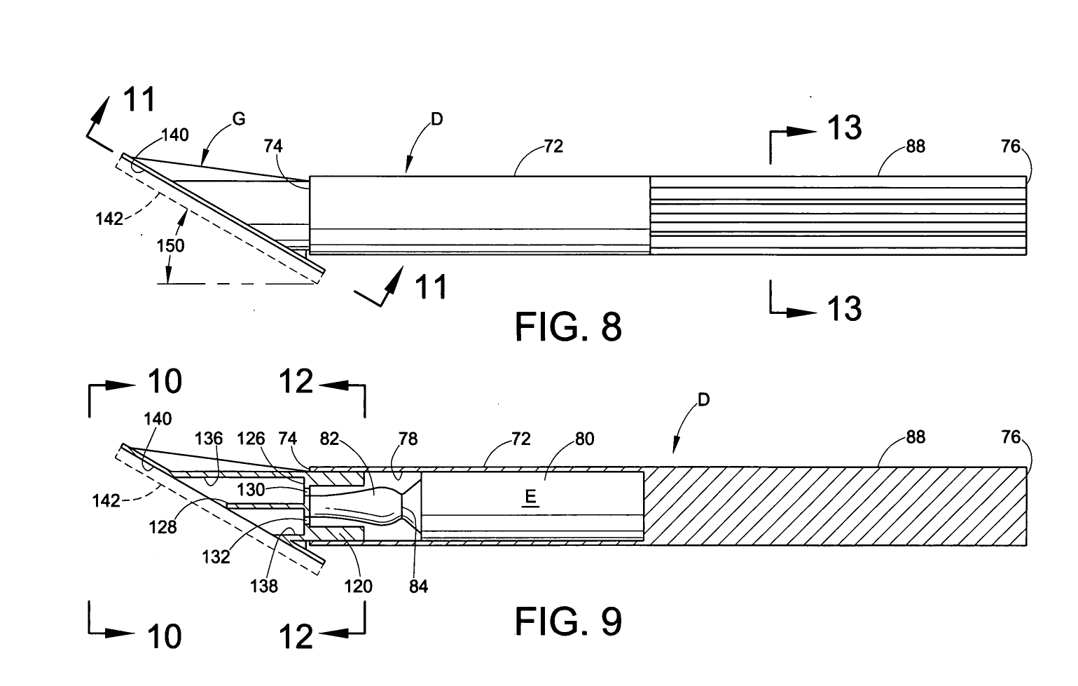

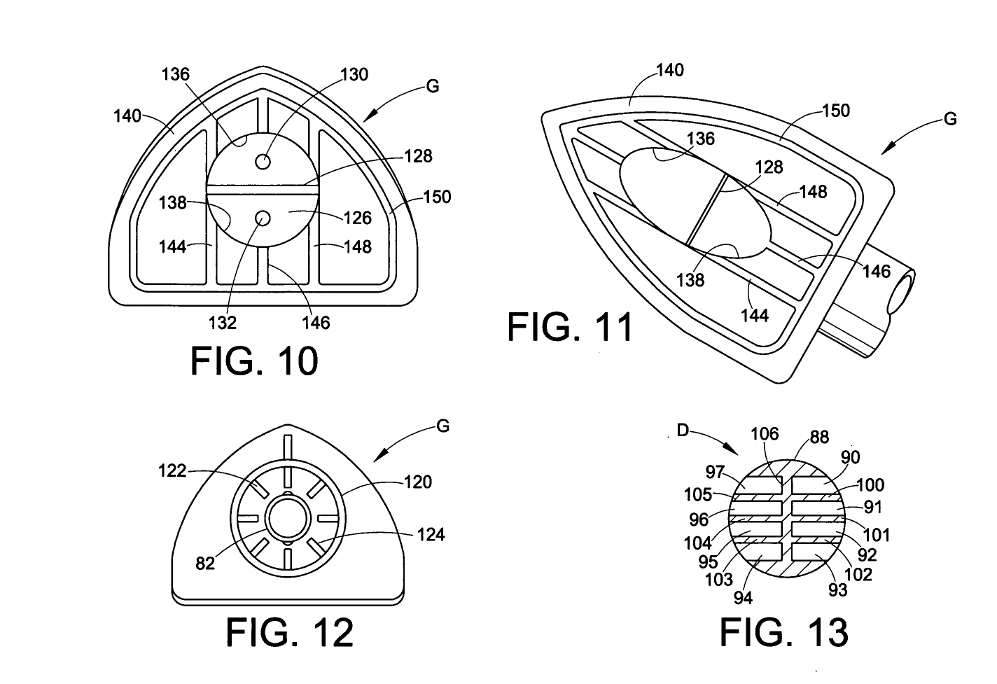

FIGS. 8-13 show another arrangement of a larger applicator/dispenser D having a generally tubular body 72 with front and rear ends 74, 76. Front end 74 is open to a generally cylindrical front solution chamber 78 in which an ampoule E is received. Ampoule E has a body portion 80 and a neck 82 connected thereto. A score line 84 between neck 82 and body 80 facilitates separation of the neck 82 from the body 80 to release the contents of the body 80. The ampoule forms a sealed rupturable container for the surface treatment solution.

The rear end portion 88 is molded of plastic material with a plurality of longitudinal grooves 90-97 separated by lateral webs 100-105 extending out from a central web 106. The outer peripheral shape of rear end portion 88 is generally cylindrical at the same diameter as the front end portion having solution chamber 78 therein.

A tip member G has a generally cylindrical tail portion 120 closely received in open front end 74 of tubular body 80 and suitably secured therein as by adhesive or welding. As shown in FIG. 12, cylindrical tail portion 120 of tip member G has a plurality of circumferentially-spaced longitudinal ribs extending radially inwardly thereof. Only two of the eight ribs are designated by reference numbers 122, 124. The radial inner ends of the ribs are on the periphery of a cylinder and provide a cavity in which ampoule neck 82 is received. A partition wall 126 has a divider wall 128 extending generally perpendicular therefrom, and a pair of passages 130, 132 through partition wall 126 communicate with larger passages 136, 138 on opposite sides of divider wall 128.

Tip member G has a generally triangular shaped front face 140 to which a solution distributing flat pad 142 is attached by way of adhesive or ultrasonic welding. The pad may be of the same material as described with reference to FIGS. 1-7. A plurality of spaced-apart grooves or flow channels 144, 146, 148 and a peripheral groove or flow channel 150 extend across and around the face 140 to provide flow channels for solution exiting passages 136, 138 on opposite sides of divider 128. The grooves 144, 146, 148 intersect the passages 136, 138. The pad 142 may be adhesively or ultrasonically bonded to surface 140 only around the periphery thereof outwardly of peripheral groove 150, or may be adhesively bonded to the entire surface 140 including between grooves 144, 146, 148 and 150, but not to the groove surfaces. Front face 140 and the outer surface of pad 142 are inclined to the longitudinal axis of tubular body 72 at an angle 150 in FIG. 8 of around 30°.

The applicator/dispenser of FIGS. 8-13 may be used for applying solutions to vehicle windshields and windows, as well as for applying solutions to other surfaces, and the front face 140 and pad 142 may be curved or otherwise shaped to generally conform to the shape of a surface to be treated. The container defined by ampoule E may be ruptured in generally the same manner as described with reference to FIGS. 1-7 and 14. With neck 82 broken off from body 80, solution flows through passages 130, 132 for distribution on pad 142.

Obviously, rupturable containers other than a frangible ampoule may be used for the treatment solution. Also, treatment solution may be contained within chambers 20, 78 and separated from passages 35, 37, 130, 132 by a rupturable barrier. In some arrangements, instead of the solution chamber being sealed, a separate air bleed passage may be provided in the solution chamber so that dual passages 35, 37 and 130, 132 could be replaced by a single passage. However, solution may leak through such an air bleed hole and it is more desirable to provide a sealed solution chamber from which solution may escape only to the pad.

By way of example, a removable tip member could be used to provide access to a removable or rupturable barrier, or a rupturable or removable container end portion that would be pierced by a sharp tool to release the solution. The applicator/dispenser would be held generally vertically when rupturing the barrier and then inverted after replacement of the tip member. A rupturable container also could be ruptured in other ways such as by squeezing or twisting a suitable tubular body.

The size of the passage holes 35, 37 and 130, 132 in the tip member will vary with the type of solution used and the size of the applicator dispenser. A single hole that is large enough to permit ingress of air to the solution chamber while permitting outflow of solution may cause the solution to flow too rapidly to the applicator pad. Two or more smaller holes provide better control of the flow rate of solution from the solution chamber to the pad while permitting ingress of air. If the passages are too large, treatment solution will flood the pad and be wasted before it can be applied to an entire surface or to a plurality of individual substrate surfaces. For a small applicator dispenser, the cylindrical passage holes each have been around 0.0625 inch in diameter, and for the larger applicator/dispenser around 0.125 inch in diameter. The hole size may vary when there are more than two holes, and all of the holes do not necessarily have to be the same size.

The applicator/dispenser of the present application is particularly advantageous for applying thin films to surfaces by using solutions that contain polmerizable amphiphilic molecules having the intrinsic ability to self-assemble into a thin film. By way of example, descriptions of such materials and their ability to form thin films are contained in: W. C. Bigelow et al, J. Colloid. Sci., 1, 513-538 (1946); L. H. Lee, J. Colloid. & Interface Sci., 27, 751-760 (1968); E. E. Polymeropoulos et al, J. Chem. Phys., 69, 1836-1847 (1978); and J. Sagiv, U.S. Pat. No. 4,539,061, issued Sep. 3, 1985. The disclosures of which are hereby incorporated herein by reference. These publications disclose compositions that include solvents in which a film forming substance is soluble, and the solvents usually are toxic and environmentally unfriendly. Highly liquid compositions also lose their usefulness very rapidly when exposed to airborne moisture because the amphiphilic molecules are highly reactive with water and tend to form molecular agglomerations that precipitate out of the solution.

Compositions and methods for use in applying ultra thin films of self-assembling amphiphilic molecules to substrate surfaces are described in our commonly assigned U.S. Pat. Nos. 5,078,791; 5,106,561; 5,166,000; 5,173,365; 5,204,126; 5,219,654; 5,300,561 and 6,206,191, the disclosures of which are hereby incorporated herein by reference. These compositions and methods are advantageous for providing ultrathin films on porous and non-porous surfaces of such materials as glass, ceramic, porcelain, fiberglass, metals and plastics.

The film serves one or more of a variety of purposes including scratch resistance, corrosion protection, protection for anti-reflective coatings on lenses, friction reduction, print priming, moisture barriers, and the like. For example, the films may be used for coating laboratory glassware and for providing a non-stick coating for pots, pans, dishes or utensils. These films are particularly advantageous for use on anti-reflective glass and plastic lens surfaces, including plastic eyewear lenses manufactured from CR-39 (trademark of PPG Industries), polycarbonate and high index resins that are pre-treated with a hard coat for scratch resistance.

These coating materials provide a hydrophobic film that seals the pores and microscopic imperfections on a surface to which the film is applied, and provides a stain resistant and protective surface.

Methods for applying ultrathin films of amphiphilic molecules to different substrates having surfaces that are chemically reactive with amphiphilic molecules are described in the articles and the U.S. patents incorporated by reference above. The molecules attach themselves to the substrate surface by various reactions and forces, and are primarily chemically bound to the surface. The molecules self-assemble and self-polymerize on the surface to form the substantially continuous ultrathin film having a substantially uniform thickness.

As used in the context of this application, a film forming substance is one containing amphiphilic molecules that are capable of self-assembly, self-polymerization and chemical bonding to chemical groups on the substrate surface or within the surface matrix to form a substantially continuous ultra thin film of substantially uniform thickness. A substantially continuous film is one that is substantially unbroken except for the presence of relatively minor defects or imperfections, such as random and widely scattered pinholes.

An amphiphile contains a polar region and a non-polar region. Amphiphiles that can be used to form thin films in accordance to the present application include, but are not necessarily limited to, the following:

The polar segment of the amphiphile can be a carboxylic acid, alcohols, thiols, primary, secondary and tertiary amines, cyanides, silane derivatives and sulfonates and the like.

The non-polar or apolar component typically consists mainly of alkyl or partial and perfluorinated alkyl groups, alkyl ether or partial and perfluorinated alkyl ether groups. These apolar regions may include diacetylene, vinyl-unsaturated or fused linear or branched aromatic rings.

In one arrangement, the film forming substance consists essentially of RmSiXn where the non-polar R is an alkyl, fluorinated alkyl, alkyl ether or fluorinated alkyl ether of about 1-30 carbon atoms and most preferably about 6-30 carbon atoms. The alkyl chain may contain diacetylene, vinyl-unsaturated, single aromatic and fused linear or branched aromatic rings. In the above formula X is selected from the group consisting essentially of halogens, hydroxy, alkoxy and acetoxy. In the formula, m is 1-3, n is 1-3 and m+n equal 4. In still another arrangement, R may be a substituted silane or siloxane.

By way of example, RmSiXn bonds to surfaces of metal oxides that contain some residual atmospheric moisture. Metal oxide surfaces to which the amphiphilic molecules chemically bond include, but are not necessarily limited to, Si, Zr, Ti, Al, Cr, Hf, V and Ni. These metal oxide surfaces are hydrolyzed by airborne moisture to form hydroxy groups that react chemically with the amphiphilic molecules to form a chemical bond. The amphiphilic molecules self-assemble and polymerize into a continuous film, and chemically bond with the reactive moities on the metal oxide surface. The metal oxide surface may be on a rigid substrate of glass, ceramic or porcelain, or may be a metal oxide coating on a rigid or flexible substrate or film of a plastic material such as, but not necessarily limited to, polyethylene, polyethylene terephthalate (PET), polycarbonate, polypropylene and poly(methyl methacrylate) (PMMA). Films may be formed on surfaces that do not have reactive moieties by providing a primer coat of metal oxide to the surface before applying the film forming solution of amphiphilic molecules thereto.

In another arrangement, the film forming substance consists essentially of RmSHn, where R is an alkyl, fluorinated alkyl, an alkyl ether or a fluorinated alkyl ether, S is sulfur and H is hydrogen. The alkyl chain may contain diacetylene, vinyl, single aromatics, or fused linear or branched aromatic moieties. In the formula, m is 1-2 and n is 0-1.

In another arrangement for application to metal surfaces, the film forming substance consists essentially of RX, where R is an alkyl, fluorinated alkyl, an alkyl ether or a fluorinated alkyl ether. The alkyl chain may contain diacetylene, vinyl-unsaturated, single aromatic, or fused linear or branched aromatic moieties and, X is selected from the groups of —COOH, —OH and —NH2.

The applicator/dispenser of the present application is essentially of two-piece construction including the one-piece molded plastic tubular body and the tip member. The solution distributing pad and the ampoule or other receptacle are the only other components. The applicator/dispenser may be used for applying soap solutions or other cleaning solutions to surfaces, as well as for applying other solutions such as antifog. Cleaning solutions may be alkaline or commercial window/glass cleaning solutions. When used for such purposes, the solution chamber 20, 78 may be refillable or may receive a refillable receptacle that is accessed by way of a removable tip member that is threaded onto the tubular body or releasably held thereto by a snap connection.

When the ampoule or other rupturable receptacle contains a solution of amphiphilic molecules, a solvent and a drying agent, the ampoule or receptacle is purged of air by using an inert gas such as nitrogen before the container is filled with solution and sealed. Usually, the container is partially filled with the solution so that the container contains both the solution and an inert gas.

The applicator/dispenser may be made in a variety of different sizes. In one arrangement, the applicator/dispenser of FIGS. 1-7 and 14 has been made to be around the same size or a little larger than a conventional writing pen. This pen applicator holds enough solution to apply a hydrophobic film of amphiphilic molecules to up to around sixteen 70 mm optical lenses. The film is particularly advantageous when applied to silicon dioxide surfaces.

When the applicator/dispenser is used for applying a film of amphiphilic molecules, examples of surfaces that can be coated include, but are not necessarily limited to, small and large glass articles, metal oxide antireflective or mirror coated plastic surfaces (lenses of all types such as ophthalmic, sun, precision, safety sport, photonics and touchscreens), mirror coated lenses, bare glass lenses for eyeglasses, bare glass or metal oxide antireflective coated plastic and glass flashlight and tactical light lenses, binoculars, microscopes, telescopes, glass picture covers, glass watch covers, glass windows or doors, glass automotive windows and windshields, glass tables, glass displays, glass shower doors, mirrors, glass and stainless steel reactors, glass lab ware, glass artwork, glass aircraft windows or metal oxide coated plastic windows, glass skylights, glass display screens with or without a metal oxide antireflective coating, glass cookware, glass serving ware, ceramic and porcelain surfaces (tiles, sinks, floors), cookware and serving ware, fine surfaces made of siliceous materials (grout, cement), glass fax or copy machine surfaces. The film of amphiphilic molecules also can be used as a paint masking agent when painting windows or around glass, ceramic, porcelain or metal surfaces because paint or stain can be removed easily from the surface of the film.

Although the improvements of this application have been shown and described with reference to representative embodiments, it is obvious that alterations and modifications will occur to other skilled in the art upon the reading and understanding of this disclosure. Therefore, it is to be understood that the improvements may be practiced otherwise than as specifically described herein while remaining within the scope of the claims.

1. Apparatus for applying an hydrophobic film of polymerizable amphiphilic molecules to a surface comprising:
a hand-held applicator/dispenser having an applicator pad and a solution chamber;
said solution chamber having a solution therein that includes a film forming material of polymerizable amphiphilic molecules;
said solution being releasable from said solution chamber to wet said pad;
whereby said pad is movable across a surface to transfer the solution thereto and the amphiphilic molecules in the film forming material self-assemble and chemically bond to the surface in an hydrophobic thin film.

2. The apparatus of claim 1 wherein the film forming material is RmSiXn where the non-polar R is a substituted silane or siloxane, an alkyl, a per-fluorinated alkyl, an alkyl ether, or a per-fluorinated alkyl either group of 6-20 carbon atoms, where X is selected from the group consisting of halogens, hydroxy, alkoxy and acetoxy groups, and where m is 1-3, n is 1-3 and m+n equal 4.

3. The apparatus of claim 1 wherein the film forming material is RX where R is apolar and selected from the group consisting of alkyl, fluorinated alkyl, alkyl ether or fluorinated alkyl ether having an alkyl chain that may or may not contain polymerizable units of vinyl, acetylene or diacetylene, single aromatic moieties, fused linear moieties or branched aromatic moieties, and where X is selected from the group consisting of
—COOH, —OH and —NH2.

4. The apparatus of claim 1 wherein the film forming material is RmSHn where R is apolar and selected from the group consisting of alkyl, fluorinated alkyl, alkyl ether or fluorinated alkyl ether having an alkyl chain that may or may not contain polymerizable units of vinyl, acetylene or diacetylene, single aromatic moieties, fused linear moieties or branched aromatic moieties, where m is 1-2 and n is 0-1.

5. The apparatus of claim 1 wherein the solution is in a sealed container that is positioned in said solution chamber.

6. The apparatus of claim 5 wherein said sealed container is rupturable by deforming said applicator/dispenser to provide flow of said solution to said pad.

7. The apparatus of claim 1 including a passage between said pad and said solution chamber, and a separable barrier normally separating said solution chamber from said passage, said barrier being separable to provide flow of said solution through said passage to said pad.

8. The apparatus of claim 7 wherein said separable barrier is a separate sealed receptacle that contains said solution and is positioned in said solution chamber.

9. The apparatus of claim 1 wherein said pad is of a material that will not leave a residue on a surface, will not dissolve in solvent, will not scratch the surface and will not swell when wetted with the solution.

10. The apparatus of claim 1 wherein said pad is an open cell plastic foam.

11. The apparatus of claim 1 wherein said applicator/dispenser has a passageway between said pad and said solution chamber and said passageway includes at least two spaced-apart independent passages.

12. The apparatus of claim 1 wherein said applicator/dispenser is an elongated body having opposite ends, one of said opposite ends being an open end to said solution chamber, and said solution chamber extends over not more than 75% of the length of said body between said opposite ends thereof.

13. The apparatus of claim 12 including a tip member having a tail portion received in said open end, said pad being attached to said tip member opposite from said tail portion thereof.

14. The apparatus of claim 13 including a longitudinal passageway in said tip member communicating between said pad and said solution chamber.

15. The apparatus of claim 14 wherein said passageway comprises at least two spaced-apart independent passages.

16. The apparatus of claim 13 wherein said tail portion has a tail cavity therein and said tip member has a passageway communicating between said pad and said tail cavity.

17. The apparatus of claim 16 wherein said solution is in a frangible receptacle that is received in said solution cavity and has a receptacle neck portion received in said tail cavity.

18. The apparatus of claim 13 wherein said tip member is attached to said applicator/dispenser body by a heat shrinkable sleeve.

19. The apparatus of claim 13 wherein said tip member is bonded to said applicator/dispenser body.

20. The apparatus of claim 19 wherein said tip member is bonded by adhesive.

21. The apparatus of claim 19 wherein said tip member is bonded by ultrasonic welding.

22. The apparatus of claim 13 wherein said tip member has a head portion to which said pad is attached, said head portion being hollow to provide a head cavity that is separated from said tail portion by a tip wall, a longitudinal divider extending along said head cavity from said tip wall, and passageways through said tip wall for providing communication between said solution chamber and said head cavity on both sides of said divider.

23. The apparatus of claim 1 wherein said solution chamber has an open end, a tip member having head and tail portions, said tail portion being attached to said open end and said pad being attached to said head portion, said open end having a central longitudinal axis, and at least two passages through said tip member spaced outwardly from said axis for providing communication between said pad and said solution chamber.

24. The apparatus of claim 1 wherein the solution in the solution chamber comprises amphiphilic molecules, a solvent and a drying agent.

25. The apparatus of claim 24 wherein the drying agent is also a catalyst for polymerization of the amphiphilic molecules.

26. The apparatus of claim 24 wherein the solution chamber is party filled with said solution and the remainder is filled with an inert gas.

27. The apparatus of claim 24 wherein the solution is in a rupturable receptacle that is received in said solution chamber.

28. The apparatus of claim 27 wherein the rupturable receptacle is a frangible ampoule.

29. A method of providing a film of polymerizable amphiphilic molecules on a surface comprising the steps of:
wetting a porous pad with a solution that includes a film forming material of polymerizable amphiphilic molecules;
covering a surface with the solution by moving the pad across the surface to transfer solution from the pad to the surface;
allowing the amphiphilic molecules in the solution to self-assemble and chemically bond to the surface in an hydrophobic thin film; and
removing excess solution from the surface.

30. The method of claim 29 including the step of providing a primer coat to the surface prior to the step of covering the surface with the solution.

31. The method of claim 30 wherein the step of providing a primer coat is carried out by providing a primer coat having hydroxyl groups that are chemically reactive with the amphiphilic molecules.

32. The method of claim 29 wherein the solution is allowed to remain on the surface for 10-500 seconds prior to carrying out said step of removing excess solution.

33. The method of claim 29 wherein the step of wetting a porous pad is carried out by wetting the pad with a solution that contains a film forming material of RmSiXn where the non-polar R is a substituted silane or siloxane, an alkyl, a per-fluorinated alkyl, an alkyl ether, or a per-fluorinated alkyl ether group of 6-20 carbon atoms, where X is selected from the group consisting of halogens, hydroxy, alkoxy and acetoxy groups, and where m is 1-3, n is 1-3 and m+n equal 4.

34. The method of claim 29 wherein the step of wetting a porous pad is carried out by wetting the pad with a solution that contains a film forming material of RX where R is apolar and selected from the group consisting of alkyl, fluorinated alkyl, alkyl ether or fluorinated alkyl ether having an alkyl chain that may or may not contain polymerizable units of vinyl, acetylene or diacetylene, single aromatic moieties, fused linear moieties or branched aromatic moieties, and where X is selected from the group consisting of —COOH, —OH and —NH2.

35. The method of claim 29 wherein the step of wetting a porous pad is carried out by wetting the pad with a solution that contains a film forming material of RmSHn where R is apolar and selected from the group consisting of alkyl, fluorinated alkyl, alkyl ether or fluorinated alkyl ether having an alkyl chain that may or may not contain polymerizable units of vinyl, acetylene or diacetylene, single aromatic moieties, fused linear moieties or branched aromatic moieties, where m is 1-2 and n is 0-1.

36. The method of claim 29 wherein the step of wetting a pad with a solution is carried out by wetting the pad with a solution of solvent, a film forming material of amphiphilic molecules and a drying agent.

37. The method of claim 36 wherein the film forming material of polymerizable amphiphilic molecules is present in an amount that is 0.1 to 10.0% by volume of the total solution.

38. The method of claim 36 wherein the film forming material of polymerizable amphiphilic molecules is present in an amount that is 0.5 to 2.0% by volume of the total solution.

39. The method of claim 29 wherein the step of wetting a pad is carried out by wetting a pad of open cell foam.

40. The method of claim 29 wherein the step of wetting a pad is carried out by wetting a pad that will not leave residue on a substrate surface, will not dissolve in solvent, will not scratch the substrate surface and will not swell when wetted with the solution.

41. The method of claim 29 wherein the pad is on an applicator/dispenser having a solution chamber containing the solution that includes a film forming material of polymerizable amphiphilic molecules, and said step of wetting the pad with the solution being carried out by releasing the solution from the chamber to flow into the pad.

42. The method of claim 41 wherein the solution in the chamber is separated from the pad by a rupturable barrier and said step of releasing the solution is carried out by rupturing the barrier.

43. The method of claim 41 wherein the rupturable barrier is a frangible receptacle that contains the solution and the solution is released by breaking the receptacle.

44. Apparatus for applying a solution to a surface comprising:
a hand-held applicator/dispenser having an applicator pad and a solution chamber;
a surface treating solution sealed within said solution chamber;
a passageway communicating between said solution chamber and said pad;
said passageway including at least two spaced discharge ports that discharge solution onto said pad at spaced-apart locations;
said solution being releasable from said solution chamber to flow through said passageway and said discharge ports to wet said pad;
whereby said pad is movable across a surface to transfer the solution thereto for treating the surface.

45. The apparatus of claim 44 including a rupturable barrier separating said solution from said passageway, said solution being releasable from said solution chamber by rupturing said barrier.

46. The apparatus of claim 45 wherein said solution is in a sealed receptacle that is received in said solution chamber and said receptacle is rupturable for releasing said solution.

47. The apparatus of claim 46 wherein said applicator/dispenser is an elongated generally cylindrical body having opposite ends, said receptacle being rupturable by bending said body so that it is curved along its length between said opposite ends thereof.

48. The apparatus of claim 45 wherein said applicator/dispenser is an elongated generally cylindrical body having opposite ends, said barrier being rupturable by bending said body so that it is curved along its length between said opposite ends.

49. The apparatus of claim 44 wherein said applicator/dispenser is an elongated generally cylindrical body having opposite ends and said solution chamber extends over not more than 75% of the length of said body between said opposite ends.

50. The apparatus of claim 44 wherein said solution chamber has an open end, a tip member having head and tail portions, said tail portion being attached to said open end and said pad being attached to said head portion, said open end having a central longitudinal axis, and said passageway comprising at least two passages through said tip member spaced outwardly from said axis.

51. The apparatus of claim 44 wherein said solution chamber has an open end, a tip member having head and tail portions, said tail portion being attached to said open end, said pad being attached to said head portion, said head portion being hollow to provide a head cavity that is separated from said tail portion by a tip wall, a longitudinal divider extending along said head cavity from said tip wall, and said passageway comprising at least two passages through said tip wall for providing communication between said solution chamber and said head cavity on both sides of said divider.

52. The apparatus of claim 44 wherein said applicator/dispenser comprises a generally cylindrical body having opposite ends and a generally cylindrical interior that is divided into front and rear chambers by an interior partition wall located intermediate said opposite ends.

53. The apparatus of claim 52 wherein said front chamber defines said solution chamber and said partition wall is located so that said solution chamber extends over not more than 75% of the length of said body between said opposite ends thereof.

54. Apparatus for applying a solution to a surface comprising:
a hand-held applicator/dispenser having a solution chamber with an open end;
a tip member having head and tail portions;
a pad attached to said head portion;
said tail portion being received in said open end of said solution chamber;
a bore in said tail portion;
a passageway through said head portion communicating between said pad and said bore in said tail portion;
said passageway having a smaller area than said bore in said tail portion;
said solution being releasable from said solution chamber to wet said pad;
whereby said pad is movable across a surface to transfer the solution thereto for treating the surface.

55. The apparatus of claim 54 wherein said tail portion is bonded within said open end of said solution chamber.

56. The apparatus of claim 54 wherein said applicator/dispenser is an elongated generally cylindrical body having a body length and said solution chamber has a length that is not greater than 75% of said body length.

57. The apparatus of claim 54 wherein said tip member is attached to said applicator/dispenser by a heat shrunk sleeve.

58. The apparatus of claim 54 wherein said applicator/dispenser comprises a generally cylindrical body having opposite ends and a generally cylindrical interior that is divided into front and rear chambers by an interior partition wall located intermediate said opposite ends.

59. The apparatus of claim 58 wherein said front chamber defines said solution chamber and said partition wall is located so that said solution chamber extends over not more than 75% of the length of said body between said opposite ends thereof.

60. The apparatus of claim 54 wherein said head portion is hollow to provide a head cavity that is separated from said tail portion by a tip wall, a longitudinal divider extending along said head cavity from said tip wall, and said passageway comprising at least two passages through said tip wall for providing communication between said solution chamber and said head cavity on both sides of said divider.

61. A sealed rupturable container that contains a solution of amphiphilic molecules, a hydrocarbon solvent and a drying agent.

62. The container of claim 61 wherein the amphiphilic molecules are present in the amount of 0.1 to 10% by volume of the total solution.

63. The container of claim 61 wherein the amphiphilic molecules are present in the amount of 0.5 to 2% by volume of the total solution.

64. The container of claim 61 wherein the drying agent also is a catalyst that promotes polymerization of the amphiphilic molecules when the container is ruptured and the solution is applied to a surface to which the amphiphilic molecules are chemically bondable.

65. The container of claim 61 wherein said container is a frangible ampoule.

66. The container of claim 61 wherein the container is partly filled with the solution and the remainder of the container is filled with an inert gas.

67. The container of claim 61 wherein said amphiphilic molecules comprise RmSiXn where R is non-polar and is a substituted silane, a siloxane, an alkyl, fluorinated alkyl, alkyl ether or fluorinated alkyl ether of about 1-30 carbon atoms, X is selected from the group consisting essentially of halogens, hydroxy, alkoxy and acetoxy, m is 1-3, n is 1-3 and m+n equal 4.

68. The container of claim 67 wherein the alkyl chain includes one or more of diacetylene, vinyl-unsaturated, single aromatic and fused linear or branched aromatic rings.

69. The container of claim 67 wherein R is an alkyl, fluorinated alkyl, alkyl ether or fluorinated alkyl ether of about 6-30 carbon atoms.

70. The container of claim 61 wherein said amphiphilic molecules comprise RmSHn, where R is an alkyl, fluorinated alkyl, an alkyl ether or a fluorinated alkyl ether, S is sulfur, H is hydrogen, m is 1-2 and n is 0-1.

71. The container of claim 70 wherein the alkyl chain includes one or more of diacetylene, vinyl, single aromatics, or fused linear or branched aromatic moieties.

72. The container of claim 61 wherein the amphiphilic molecules comprise RX, where R is an alkyl, fluorinated alkyl, an alkyl ether or a fluorinated alkyl ether, and X is selected from the groups of —COOH, —OH and —NH2.

73. The container of claim 72 wherein the alkyl chain includes one or more of diacetylene, vinyl-unsaturated, single aromatic, or fused linear or branched aromatic moieties.
